(19) United States
(12) Patent Application Publication
(10) Pub. No.: US 2004/0057082 A1
(43) Pub. Date: Mar. 25, 2004

(54) Method of focusing a selected scanning area for document scanning device

(76) Inventor: Rong-Ji Liu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/252,705

(22) Filed: Sep. 24, 2002

(51) Int. Cl. H04N 1/04; H04N 1/047

(52) U.S. Cl. 358/406; 358/474

(57) ABSTRACT

A method of focusing for a document scanner with respect to a selected area of a document to be scanned is disclosed. The scanner has an optic module movable in a scanning direction to perform scanning operation over the document by being driven by an optic module moving mechanism under control of a control unit. The method includes the steps of (a) selecting an area on the document to be scanned; (b) performing scanning operation over a calibration chart to obtain a set of calibration chart based focus values; (c) processing the calibration chart based focus values to obtain the focus values for the selected area; and (d) moving the optic module with respect to the document based on the focus values for the selected area and performing a scanning operation to the document.

### BACKGROUND OF THE INVENTION

1. Field of the Invention

The present invention relates generally to automatic focusing of document scanners, and in particular to automatic focusing of a document scanner with respect to a selected area of a document to be scanned.

2. The Related Art

Document scanners have been widely used to scan graphic information from reflective or transmissive original document. A major factor concerning the performance of the document scanners is scanning resolution. Excellent digitalization of documents can be obtained by upgrading resolution of the scanner. However, proper focusing is another factor for the excellent digitalization of the document.

FIG. 1 of the attached drawings shows a conventional document scanner, comprising a casing 1 having a scanning window formed by a rectangular opening to which a light-transmitting document support plate 12 is attached for supporting a document 13 to be scanned in a face down manner. A cover 14 is pivoted to one side of the casing 1 for covering the document support plate 12 and securely retaining the document 13. An optic module 2 that is mounted inside the casing 1 below the document support plate 12 is movable with respect to the document support plate 12 along a pair of rails 15a, 15b extending in a first direction indicated by arrow I.

Also referring to FIG. 2, the optic module 2 is driven by an optic module moving mechanism 3 under the control of a control unit 4 for movement in the first direction I in order to scan throughout the whole area of the document 13. The optic module 2 comprises a light source 21 for emitting and projecting a light beam toward the document 13 to be scanned. The document 13 reflects the light as indicated by 211. The reflected light 211 is redirected by a plurality of reflective mirrors 22, 23, 24, 25 toward a focusing lens 26 and forms an image of the document on an image sensing device 27, such as charge coupled device (CCD).

Conventionally, the optic module 2 is calibrated to obtain a best focus for properly forming image on the image sensing device 27. One way to calibrate the optic module 2 for the best focus is to perform a pre-scanning operation over a calibration zone located at the starting side 120 of the scanning window 12. The optic module 2 is moved in the first direction I under the guidance of the rails 15a, 15b from the starting side 120 toward an opposite ending side. Particularly, a calibration chart 16 (as shown in FIG. 3) comprising a plurality of white segments 161 and black segments 162 alternating in a lengthwise direction is mounted to an underside of the top plate 11 adjacent to the starting side 120. Proper focusing can be obtained by scanning the calibration chart 16 and analyzing the scan result.

Automatic focusing techniques currently used include document focusing technique and calibration chart focusing technique. The document focusing technique involves direct focusing for each single document to be scanned. This, although ensuring the best focus in scanning each document, is quite time consuming. In addition, it may not be possible to do automatic focusing for each document, especially when the document is folded to some extents.

As to the calibration chart focusing technique, only the focus value associated with the calibration chart is obtained for performing scanning operation on all documents. It is understandable that the focus value may not be the best focus value for all area of a document or for all documents. Using the same focus value for different documents may lead to poor scanning result at some area, especially at the side portion of the document. Moreover, it is impossible to perform focusing to any selected area of the document.

Thus, it is desired to have a method of automatic focusing with respect to a selected area of a document to be scanned for overcoming the above problems.

### SUMMARY OF THE INVENTION

A primary object of the present invention is to provide a method of area automatic focusing for a document scanner that allows for precise focusing for a selected local area of a document to be scanned and giving excellent scanning result of the local area.

Another object of the present invention is to provide a method of automatic focusing for a document scanner that allows for area focusing and scanning for arbitrarily selected areas of a document.

A further object of the present invention is to provide a fast automatic focusing process with respect to a selected area of a document.

To achieve the above objects, in accordance with the present invention, there is provided a method of focusing for a document scanner with respect to a selected area of a document to be scanned. The method includes steps of selecting an area on the document to be scanned, performing scanning operation over a calibration chart to obtain a set of calibration chart based focus values, processing the calibration chart based focus values to obtain the focus values for the selected area, and moving the optic module with respect to the document based on the focus values for the selected area and performing a scanning operation to the document. The calibration chart comprises alternating white and black segments, or alternatively comprises at least one focus zone which comprises alternating white and black bars.

### BRIEF DESCRIPTION OF THE DRAWINGS

The present invention will be apparent to those skilled in the art by reading the following description of the best modes for carrying out the invention, with reference to the attached drawings, in which:

FIG. 1 is a perspective view of a conventional document scanner;

FIG. 2 is a schematic view of the conventional document scanner;

FIG. 3 shows a conventional calibration chart for document scanners;

FIG. 4 is a schematic view of a document scanner constructed in accordance with the present invention;

FIG. 5 is a flow chart of an automatic focusing process in accordance with a first embodiment of the present invention;

FIG. 6 schematically shows a document with a selected area to be scanned with the scanner of the present invention;

FIG. 7 is a plot of focus value in accordance with the first embodiment of the present invention;

FIG. 8 is a flow chart of an automatic focusing process in accordance with a second embodiment of the present invention;

FIG. 9 is a plot of focus value in accordance with the second embodiment of the present invention;

FIG. 10 is a flow chart of an automatic focusing process in accordance with a third embodiment of the present invention;

FIG. 11 schematically shows a calibration chart in accordance with the third embodiment of the present invention;

FIG. 12 is an enlarged view of the focus zone of the calibration chart of the present invention shown in FIG. 11; and

FIG. 13 is a plot of focus in accordance with the third embodiment of the present invention.

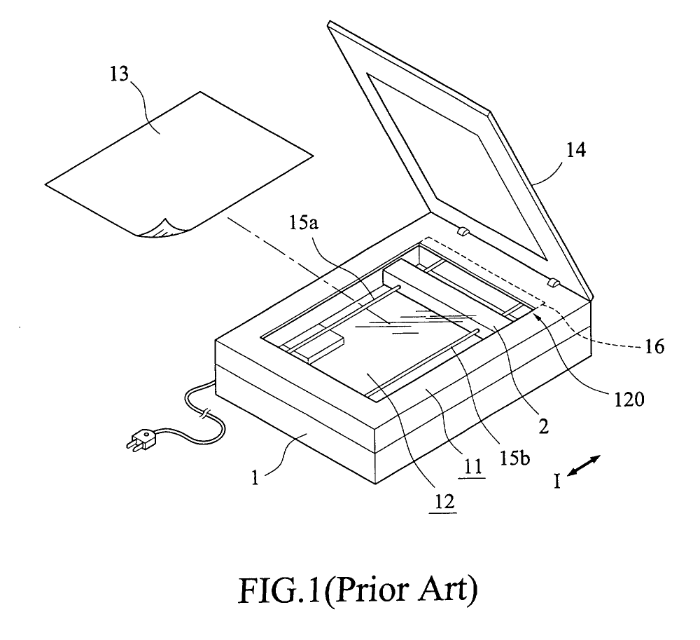

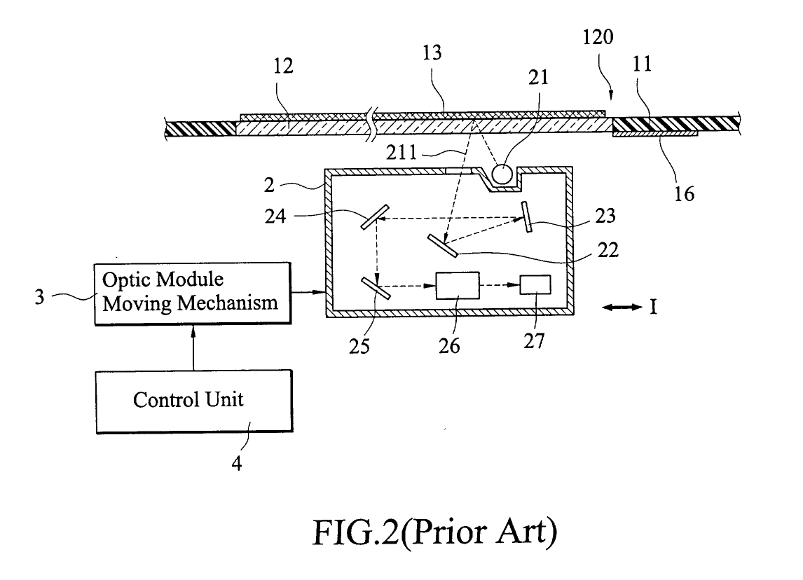

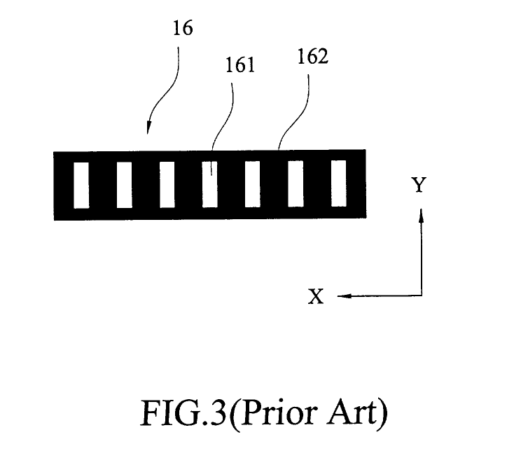

### DETAILED DESCRIPTION OF THE PREFERRED EMBODIMENTS

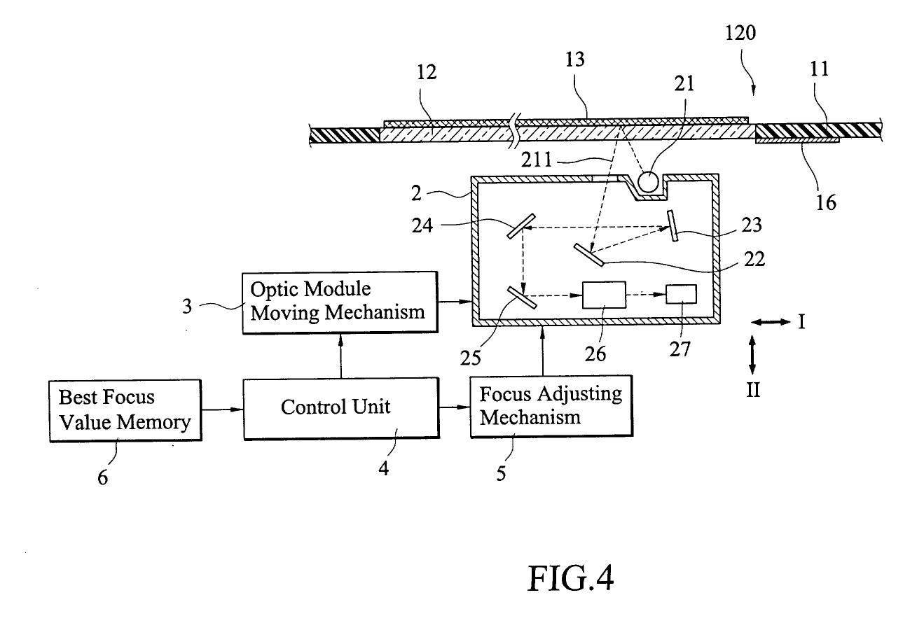

With reference to the drawings and in particular to FIG. 4, a document scanner constructed in accordance with the present invention comprising a casing (not labeled) having a top plate 11 in which a scanning window is defined for mounting a light-transmitting document support plate 12 thereon. A document 13 to be scanned is selectively positioned on the light-transmitting document support plate 12 in a face down manner. A calibration chart 16 is attached to an underside of the top plate 11 adjacent to a starting side 120 of the document support plate 12. An optic module 2 is arranged inside the casing of the scanner and below the document support plate 12. The optic module 2 comprises a light source 21 capable of projecting a light beam toward the document 13 to be scanned. The document 13 reflects the light beam as a reflected light indicated by reference numeral 211 traveling into the optic module 2. The reflected light 211 is redirected by a plurality of reflective mirrors 22, 23, 24, 25 of the optic module 2 toward a focusing lens 26 for forming an image on an image sensing device 27.

The optic module 2 is driven by an optic module moving mechanism 3 under the control of a control unit 4 to move, in a first, scanning direction indicated by arrow I that is substantially parallel to the document support plate 12, with respect to the document 13 to scan an area of the document 13 in a scan line by scan line manner.

The scanner further comprises a focus adjusting mechanism 5, which operates under the control of the control unit 4 to move the optic module 2 (or alternatively the lens 26 and the image detector 27) with respect to the document support plate 12 in a second direction indicated by arrow II that is substantially perpendicular to the document support plate 12, for adjustment of the focus position of the optic module 2.

The control unit 4 comprises a best focus value memory 6 for storage of at least one best focus value (or one set of best focus value). In a first embodiment of the present invention, the best focus value can be obtained by performing scanning operation over the calibration chart 16. The calibration chart 16 comprises white and black segments alternating in the lengthwise direction of the chart 16. The calibration chart 16 is mounted to the casing so that the lengthwise direction thereof is substantially parallel to the document support plate 12 and perpendicular to the first direction I. For simplicity, the direction that is parallel to the lengthwise direction of the calibration chart 16 in this case will also be referred to as X direction hereinafter.

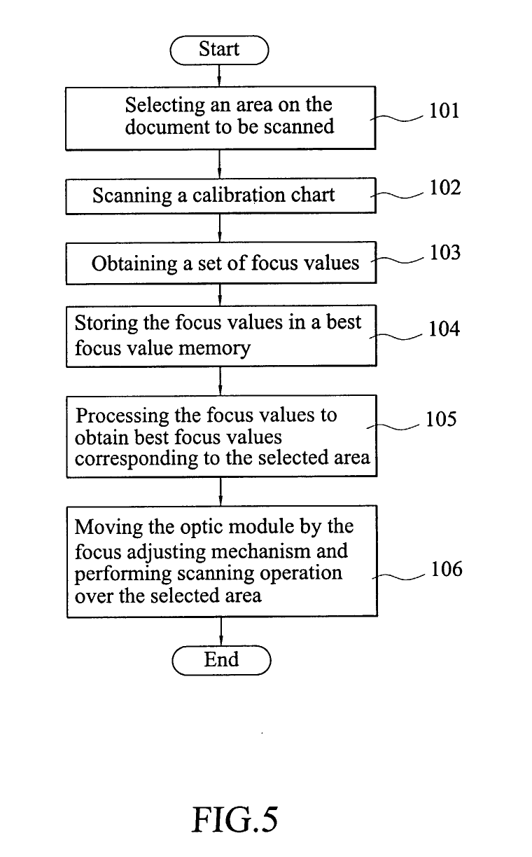

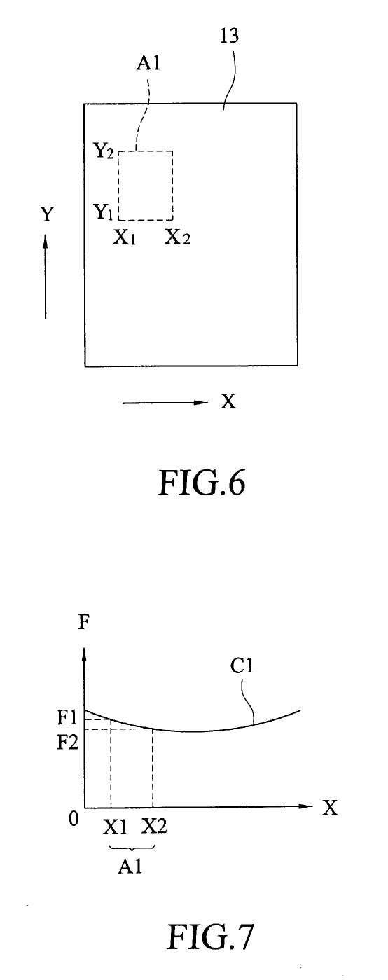

FIG. 5 shows a flow chart of a method of automatic focusing in accordance with the first embodiment of the present invention. Also referring to FIG. 6, a selected area A1 of the document 13 to be scanned is selected first (step 101). The coordinates of edges of the area A1 in the X-direction are respectively referred to as X1, X2 hereinafter. The control unit 4 commands the optic module 2 to perform a pre-scanning operation over the whole calibration chart 16 in step 102. The pre-scanning allows the scanner to obtain a focus curve C1 as shown in FIG. 7 corresponding to the calibration chart 16 (with the lengthwise direction of the calibration chart 16 corresponding to the X-direction or X-axis of the plot of FIG. 7) in step 103, and the focus curve C1 so obtained is stored in the best focus value memory 6 in step 104.

FIG. 7 shows the focus curve C1 wherein abscissa denotes positions along the lengthwise direction of the calibration chart 16 (that is positions along the X-direction) while the ordinate is the best focus value of the corresponding X-direction position obtained by scanning the calibration chart 16. The focus values F1, F2 respectively corresponding to the X1, X2 in the plot are the focus values of the two margins X1 and X2 of the selected area A1.

The control unit 4 retrieves the focus curve C1 from the best focus value memory 6 and then calculates the data to obtain the best focus value or a set of focus values corresponding to the local area A1 (step 105). Thereafter, the focus adjusting mechanism 5 moves the optic module 2 in accordance with the focus value or the set of focus values, and a scanning operation is performed over the selected area A1 in step 106.

A modification of the first embodiment can be done by pre-scanning the calibration chart 16 in advance and obtain and store the focus curve C1 in the best focus value memory 6. The focus value can be retrieved from the best focus value memory 6 once a document is to be scanned and a local area of the document is selected. The control unit 4 performs the calculation or the desired processing to obtain the focus value(s) for the selected area and conducts a scanning operation over the selected area based on the focus value(s) of the area.

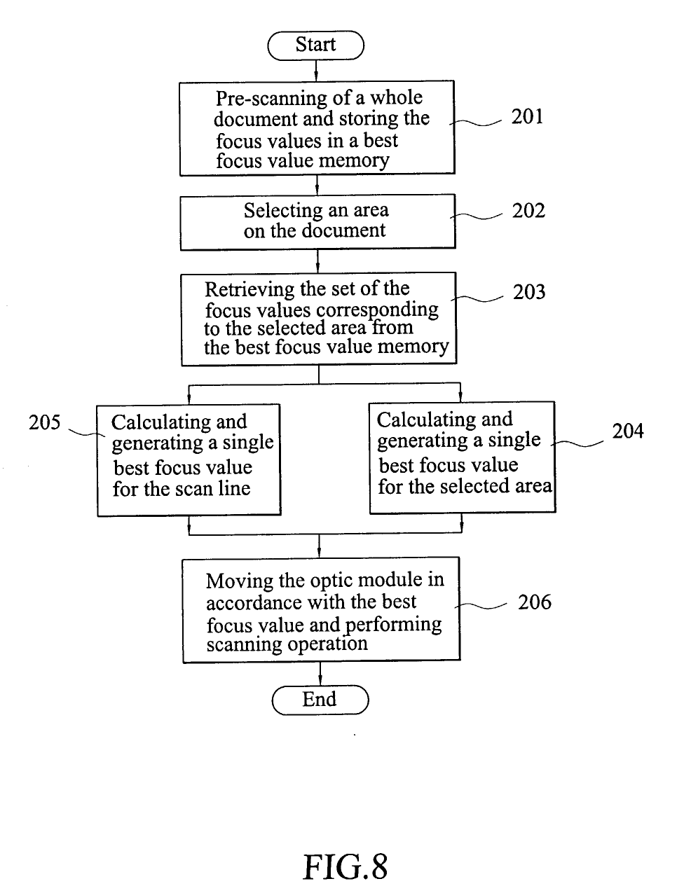

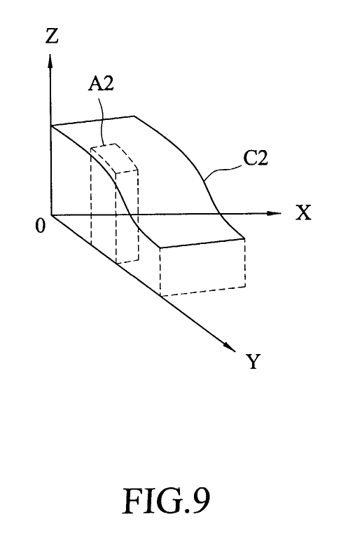

FIG. 8 shows a flow chart of focusing process in accordance with a second embodiment of the present invention. The scanner shown in FIG. 4 is employed again here in the second embodiment. In the second embodiment, a pre-scanning over the whole document to be scanned is performed first to establish a document based whole area focus values which are stored in the best focus value memory 6 in step 201. This is done by driving the optic module 2 to scan over the whole area of a document that is positioned on the document support plate 12, which gives a curved surface C2 of the focus values corresponding to the whole area of the document as shown in FIG. 9 in which X-axis indicates the X-direction as discussed above while the Y-axis corresponds to the first direction I. Z-axis stands for the focus value of the corresponding point on the document surface having coordinates (X, Y).

In step 202, a local area that is designated by A2 in FIG. 9 is selected. The control unit 4 then retrieves the focus values corresponding to the selected area A2 from the best focus value memory 6 in step 203. The focus values of all the points inside the area A2 may be used to calculate and generate a single best focus value for the whole area A2 in step 204. Alternatively, the focus values of the points one each scan line can be used to calculate and generate a single best focus value for the scan line comprised of the area A2 in step 205. In step 206, the focus adjusting mechanism 5 changes the position of the optic module 2 in accordance with the best focus value obtained in step 204 or change the position of the optic module 2 for scanning each scan line in accordance with the best focus value obtained in step 205.

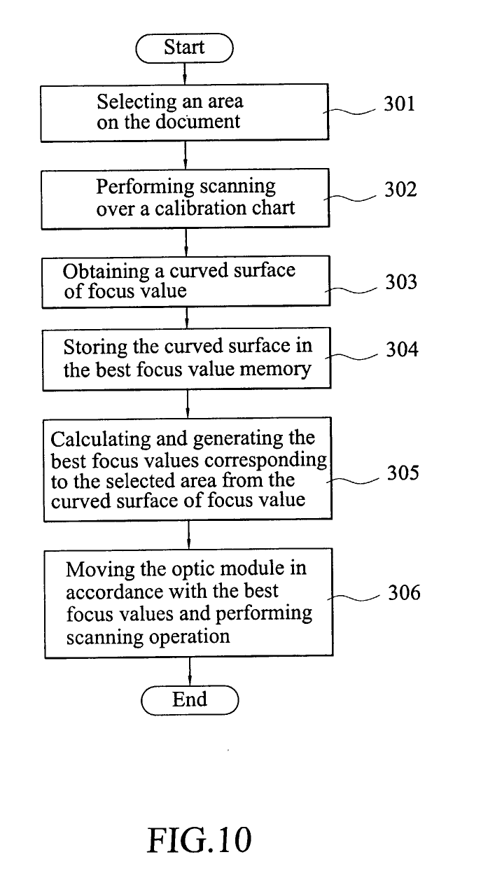

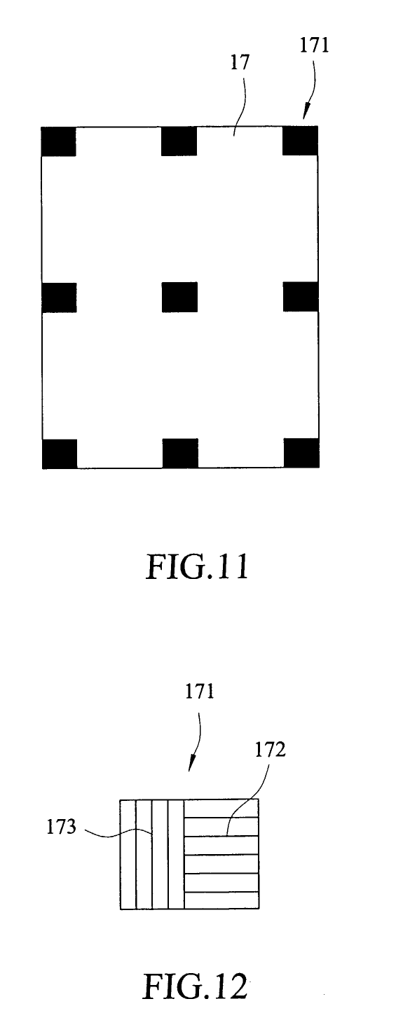

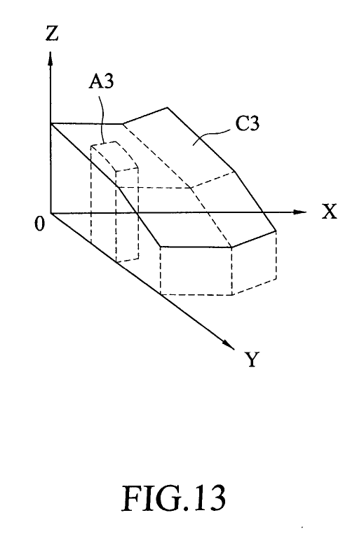

FIG. 10 shows a flow chart of focusing process in accordance with a third embodiment of the present invention, which is embodied in the scanner, illustrated in FIG. 4 also. However, a calibration chart 17 that is different from that used in the first embodiment is used. FIGS. 11 and 12 particularly show the calibration chart 17. The calibration chart 17 comprises a number of focus zones 171 each comprised of a plurality of vertical bars 172 and horizontal bars 173, as shown in FIG. 12. The calibration chart 17 allows the optic module 2 to obtain a single focus value for each focus zone 171. A curved surface C3 of the focus values corresponding to the whole area of the document as shown in FIG. 13 can be obtained based on the focus values obtained with the calibration chart 17. The curved surface C3 shown in FIG. 13 indicates the best focus value in the Z-axis for each corresponding point having coordinates (X, Y).

The focusing process of the third embodiment comprises a step of manually selecting a local area A3 (see FIG. 13) for scanning in step 301. The control unit 4 commands the optic module 2 to perform a scanning operation over the calibration chart 17 in step 302, and the curved surface C3 of focus value is obtained in step 303. The curved surface is then stored in the best focus value memory 6 in step 304.

Thereafter, the control unit 4 retrieves the focus values, calculates and generates the best focus values corresponding to the area A3 from the best focus value memory 6 in step 305. The focus adjusting mechanism 5 performs adjustment of the position of the optic module 2 in accordance with the retrieved focus values, and the optic module 2 performs the scanning operation over the area A3 in step 306.

To this point, it is apparent to those skilled in the art that the focusing with respect to a selected local area of a document to be scanned allows for precise focusing of the scanner inside the selected local area and a scanning operation with the best focus value can be performed over the selected area with the precise focus whereby the area automatic focusing can be done efficiently and a clear image can be obtained for the local area.

Although the present invention has been described with reference to the best modes of operation thereof, it is apparent to those skilled in the art that a variety of modifications and changes may be made without departing from the scope of the present invention which is intended to be defined by the appended claims.

What is claimed is:

1. A method of focusing for a document scanner with respect to a selected area of a document to be scanned, wherein the scanner comprises an optic module movable in a scanning direction to perform scanning operation over the document by being driven by an optic module moving mechanism under control of a control unit, the method comprising the following steps:
(a) selecting an area within the document to be scanned;
(b) scanning over a calibration chart to obtain at least one calibration chart based focus value;
(c) processing the calibration chart based focus value to obtain at least one focus value for the selected area; and
(d) moving the optic module with respect to the document based on the focus value for the selected area and scanning the document.

2. The method as claimed in claim 1, further comprising a step of storing the calibration chart based focus values in a best focus value memory after step (b).

3. The method as claimed in claim 1, wherein the calibration chart employed in step (b) comprises alternating white and black segments.

4. The method as claimed in claim 1, wherein the calibration chart comprises at least one focus zone, the focus zone comprised of a plurality of vertical bars and horizontal bars.

5. A method of focusing for a document scanner with respect to a selected area of a document to be scanned, wherein the scanner comprises an optic module movable in a scanning direction to perform scanning operation over the document by being driven by an optic module moving mechanism under control of a control unit, the method comprising the following steps:
(a) pre-scanning a calibration chart with the optic module to obtain and store at least one calibration chart based focus value in a best focus value memory;
(b) selecting an area within the document to be scanned;
(c) accessing the calibration chart based focus value from the best focus value memory;
(d) processing the calibration chart based focus value to obtain the focus value corresponding to the selected area from the calibration chart based focus value; and
(e) moving the optic module with respect to the document based on the focus value for the selected area and scanning the document.

6. The method as claimed in claim 5, wherein the calibration chart employed in step (a) comprises alternating white and black segments.

7. The method as claimed in claim 5, wherein the calibration chart comprises at least on focus zones, the focus zone comprised of a plurality of vertical bars and horizontal bars.

8. A method of focusing for a document scanner with respect to a selected area of a document to be scanned, wherein the scanner comprises an optic module movable in a scanning direction to perform scanning operation over the document by being driven by an optic module moving mechanism under control of a control unit, the method comprising the following steps:
(a) pre-storing a set of focus values in a best focus value memory of the document scanner, the set of focus values being obtained by performing a whole area scanning operation over the document;
(b) selecting an area within the document to be scanned;
(c) retrieving the focus values of the whole area of the document from the best focus value memory;
(d) selecting the focus values corresponding to the selected area from the retrieved focus values;
(e) processing the calibration chart focus values corresponding to the selected area to obtain a focus value;
(f) processing the calibration chart based focus value to obtain the focus value corresponding to the selected area from the calibration chart based focus value; and
(g) moving the optic module with respect to the document based on the focus values for the selected area and scanning the document.

9. The method as claimed in claim 8, wherein in step (a), the pre-stored focus values are obtained by scanning over a document to be scanned in order to obtain the focus values.

10. The method as claimed in claim 8, wherein the processing performed in step (e) is to calculate out a single best focus by manipulating the focus curve.

11. The method as claimed in claim 8, wherein the processing performed in step (e) is to calculate out a single best focus for each scan line.
